(19) United States
(12) Patent Application Publication
(10) Pub. No.: US 2005/0226171 A1
(43) Pub. Date: Oct. 13, 2005

(54) Information processing apparatus and information processing method

(75) Inventor: Shinichi Uchikawa, Kawasaki-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/103,305

(22) Filed: Apr. 11, 2005

(30) Foreign Application Priority Data
Apr. 12, 2004 (JP) 2004-116801

(51) Int. Cl. H04L 12/28

(52) U.S. Cl. 370/254

(57) ABSTRACT

An information processing apparatus connected to a plurality of devices through a communication medium is provided. The apparatus includes a transmitting unit adapted to transmit a search request to one or more devices existing in a first area; a receiving unit adapted to receive a response to the search request from one or more devices; and a control unit adapted to control the transmitting unit to transmit the search request to one or more devices existing in a second area when the number of devices that have responded to the search request transmitted by the transmitting unit is less than a predetermined number.

### BACKGROUND OF THE INVENTION

1. Field of the Invention

The present invention relates to an information processing apparatus, an information processing method, and a storage medium for searching for a device having a desired service among a plurality of devices connected through a network.

2. Description of the Related Art

Hitherto, network devices connected to a network so as to be controlled by a computer through the network, such as printers and multifunction devices, have been used. In an environment where a large number of these network devices are connected through a network, a user searches for a device which provides a desired service among the large number of network devices providing various services (e.g., a print service provided by a printer; and scan, print, and storage services provided by a multifunction device), and uses the desired service.

Various methods have been used to search for a service provided by a device on a network. As one of them, a service search method using multicast is being developed.

By using the multicast, same data can be simultaneously transmitted to a plurality of destination addresses. Further, by transmitting data to a special address provided for multicast, the data can be transmitted to nodes capable of receiving data from the multicast address.

With this characteristic, packet routing by a router is permitted to a multicast packet. Whether a packet received by a router should be transferred to another network is generally determined according to the following rule.

FIG. 11 shows a structure of a packet. A TCP/IP packet has a structure denoted by reference numeral 1101. In this structure, an IP header unit 1102 includes a TTL (time to live) area 1103. An initial value is set to the TTL area by a transmitter side. Routers which have received this packet decrease the TTL value one by one and transfer the packet to another network. At that time, when the TTL value of the received packet is 1 or less, the router discards the packet instead of transferring it. Accordingly, an unnecessary packet is prevented from being permanently transferred over networks. Under this rule, a transmitter of a packet can control the transfer range of the packet by appropriately setting the TTL value of the packet that the transmitter transmits first.

Japanese Patent Laid-Open No. 2000-244533 discloses TTL for managing IP addresses of network devices.

However, when a service is searched for by a service discovery protocol using the above-described known multicast packet technique, if the TTL value of a multicast search packet is small, the search packet does not reach the service to be searched for, and thus a desired service cannot be found. For example, when the TTL value of a search packet is 1, the search packet cannot go over a router when the router exists between a service search system and the service to be searched for in a network configuration, even if the service search system is physically next to the service. As a result, this service cannot be found.

Also, when a service is searched for by a service discovery protocol using the multicast packet technique, the range of search, e.g., the TTL of a multicast packet, depends on implementation of a service search system, although search conditions such as features of the service can be set. Therefore, a user of this service search system cannot set or change the TTL of a multicast packet.

Further, in the service search by a service discovery protocol using the multicast packet technique, when the search range is widely set in the service search system, services on another network are unintentionally searched for even when the searcher wants to search for only services on the same network.

For example, assume that ten services to be searched for exist in the same network environment as the service search system and that thirty services to be searched for exist in an adjoining network. In this case, when the searcher searches for services by using a service search apparatus in which TTL is set to two, forty services are found, so that the searcher must select a desired service from among the forty services.

### SUMMARY OF THE INVENTION

The present invention has been made in view of the above-described problems and provides an information processing apparatus enabling a user to efficiently find a device providing a service desired by the user while a search is performed for services provided by devices on a network.

According to a first aspect of the present invention, an information processing apparatus connected to a plurality of devices through a communication medium is provided. The apparatus includes a transmitting unit adapted to transmit a search request to one or more devices existing in a first area; a receiving unit adapted to receive a response to the search request from one or more devices; and a control unit adapted to control the transmitting unit to transmit the search request to one or more devices existing in a second area when the number of devices that have responded to the search request transmitted by the transmitting unit is less than a predetermined number.

According to a second aspect of the present invention, an information processing apparatus connected to a plurality of devices through a network is provided. The apparatus includes a transmitting unit adapted to transmit a search request for searching for one or more devices to the network; a receiving unit adapted to receive a response to the search request; a determining unit adapted to determine whether the number of devices satisfying the search request is less than a predetermined number; and a control unit adapted to control the transmitting unit to retransmit the search request by widening a range within which the search request is transmitted if it has been determined that the number of devices satisfying the search request is less than the predetermined number.

According to a third aspect of the present invention, an information processing apparatus connected to a plurality of devices through a network is provided. The apparatus includes a transmitting unit adapted to transmit a search request for searching for one or more devices to the network; a receiving unit adapted to receive a response to the search request; a determining unit adapted to determine whether the number of devices satisfying the search request is greater than a predetermined number; and a control unit adapted to control the transmitting unit to retransmit the search request by narrowing a range within which the search request is transmitted if it has been determined that the number of devices satisfying the search request is greater than the predetermined number.

Other features and advantages of the present invention will be apparent from the following description when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate an embodiment of the invention and, together with the description, serve to explain the principles of the invention.

FIG. 1 shows an example of a configuration of a service search system according to an embodiment of the present invention.

FIG. 2 shows an example of a configuration of a computer apparatus serving as a service search apparatus according to the embodiment.

FIG. 3 shows a hardware structure of a network device according to the embodiment.

FIG. 4 shows an operation of searching for a service using a general multicast technique.

FIG. 5 is a flowchart showing an operation of service search software according to the embodiment.

FIG. 6 shows transition of screens in a host computer in which the service search software of the embodiment is executed.

FIG. 7 shows an example of a screen 600 shown in FIG. 6.

FIG. 8 shows an example of a screen 601 shown in FIG. 6.

FIG. 9 shows an example of a screen 602 shown in FIG. 6.

FIG. 10 shows an example of a screen 603 shown in FIG. 6.

FIG. 11 shows a configuration of a general TCP/IP packet.

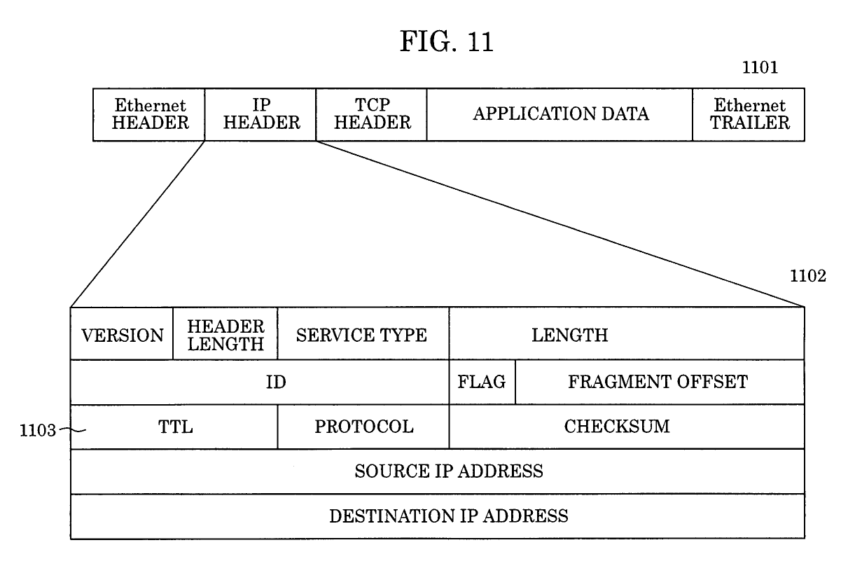

### DESCRIPTION OF THE EMBODIMENT

Hereinafter, an embodiment of the present invention will be described with reference to the drawings.

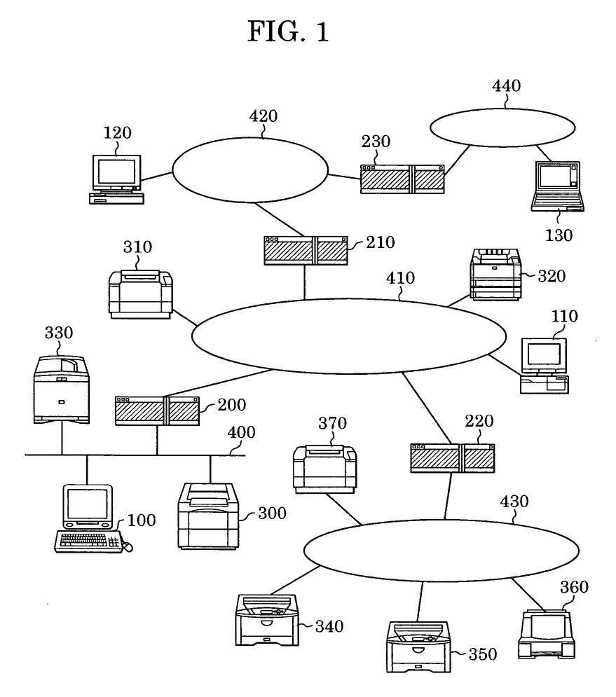

FIG. 1 shows an example of a configuration of a service search system according to the embodiment. Service search software operates in PCs 100, 110, 120, and 130. Routers 200, 210, 220, and 230 connect networks 400, 410, 420, 430, and 440 having different subnet addresses, respectively. Further, devices 300, 310, 320, 330, 340, 350, 360, and 370 capable of responding to a search by the service search software are connected to the respective networks.

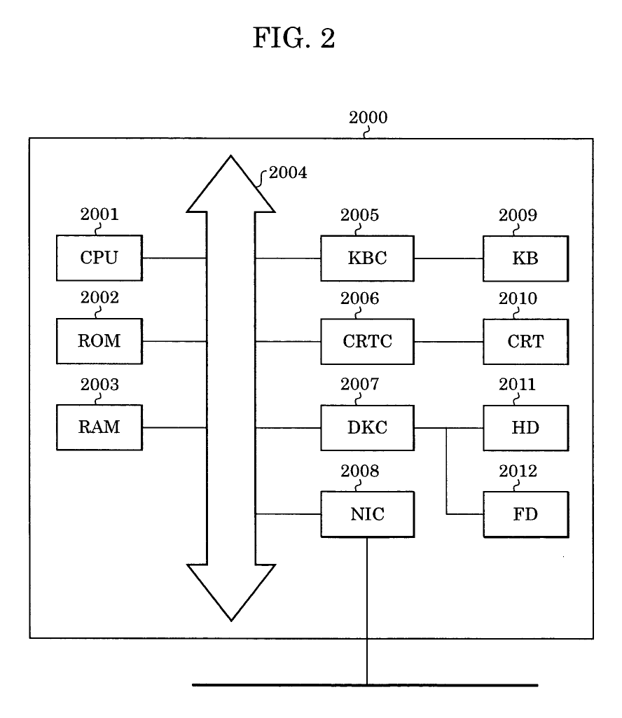

FIG. 2 is a block diagram showing an example of a configuration of a computer apparatus 2000, which can be used as a service search apparatus of the present invention. The block diagram shown in FIG. 2 corresponds to each of the PCs 100, 110, 120, and 130 shown in FIG. 1. The service search apparatus in the present invention can be realized by a computer apparatus such as a conventional computer apparatus.

In FIG. 2, a hard disk (HD) 2011 stores a program for allowing the computer apparatus 2000 to function as the service search apparatus in the embodiment. Hereinafter, unless otherwise specified, the entity of executing processing of the service search apparatus is a CPU 2001, and the entity of control on the software is the service search software stored in the HD 2011. The computer apparatus further includes conventional computer components connected to the CPU 3001 via a system bus 3004. These conventional computer components include a read-only memory (ROM) 2002, a random access memory (RAM) 2003, a keyboard controller (KBC) 2005, a CRT controller (CRTC) 2006, a disk controller (DKC) 2007 and a network interface card (NIC) 2008. The NIC 2008 allows the computer apparatus 2000 to communicate with other devices over a network, such as a local area network (LAN) or a wide area network (WAN). The KBC 2005 controls an input device, such as a keyboard (KB) 2009. The CRTC 2006 controls an output device, such as a CRT (cathode ray tube) 2010. The DKC 2007 controls one or more external storage devices, such as a hard disk 2011 and a floppy drive (FD) 2012.

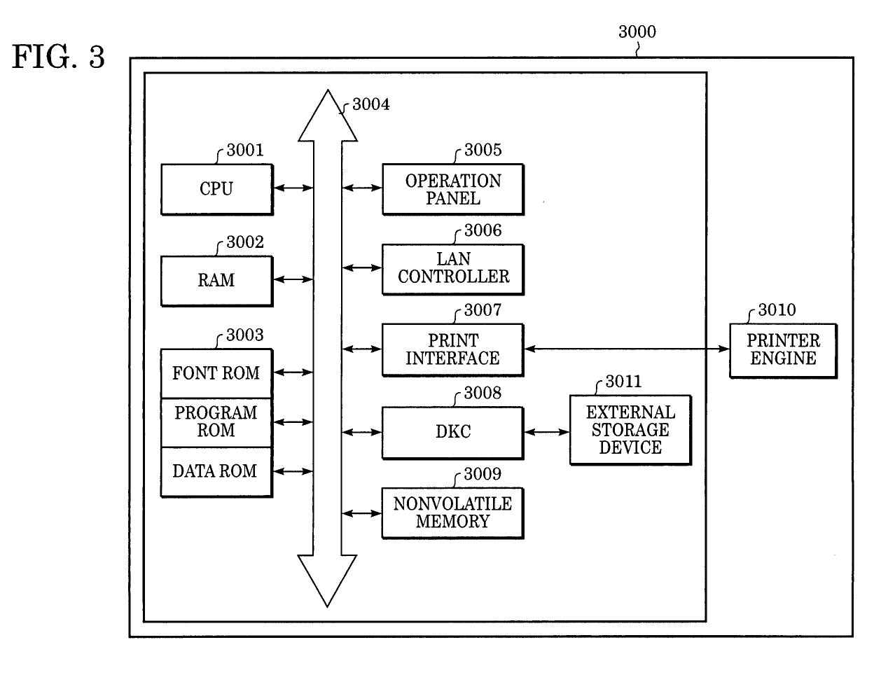

FIG. 3 is a block diagram illustrating a hardware configuration of a network device. The block diagram shown in FIG. 3 shows any of the devices 300, 310, 320, 330, 340, 350, 360, and 370 shown in FIG. 1. In this case, a laser beam printer is used as an example, but the network device in the present invention is not limited to a printer, but may be other devices such as a copier, a multifunction device, a scanner, and a fax machine.

A printer 3000 shown in FIG. 3 includes a printer CPU (CPU) 3001. The CPU 3001 generally controls accesses with various devices connected to a system bus 3004 based on a control program stored in a program ROM in a ROM 3003. Also, the CPU 3001 outputs an image signal as output information to a printing unit (printer engine) 3010, which is connected through a print interface 3007. The program ROM in the ROM 3003 stores a control program or the like executable by the CPU 3001. A font ROM in the ROM 3003 stores font data (including outline font data) used for generating the output information. A data ROM in the ROM 3003 stores information and so on used on a host computer.

The CPU 3001 is capable of communicating with the host computer on a network through a LAN controller 3006. A RAM 3002 mainly functions as a main memory and a work area of the CPU 3001. The RAM 3002 is configured so that the memory capacity can be expanded by an optional RAM connected to an additional port (not shown). The RAM 3002 is used as an output-information expanding area, an environment-data storage area, and so on.

An external storage device 3011 is a hard disk (HD), an integrated circuit (IC) card, or the like, and the access thereto is controlled by a disk controller (DKC) 3008. The HD is used for storing font data, an emulation program, form data, and so on, and as a job storing area for temporality spooling a print job and externally controlling the spooled job.

Reference numeral 3005 denotes an operation panel, in which a user can input various information by using software keys. The above-described external storage device is not limited to only one. By providing one or more external storage devices, a plurality of external memory devices storing an internal font, an optional font card, and a program for interpreting a printer control language of a different language system, can be connected. A nonvolatile memory 3009 stores printer-mode setting information from the operation panel 3005 in units of users and groups.

Although not shown, the printer 3000 is capable of being optionally equipped with various expansion devices, such as a finisher having stapling and sorting functions and a double-sided printing device having a double-sided printing function. The operation thereof is controlled by the CPU 3001.

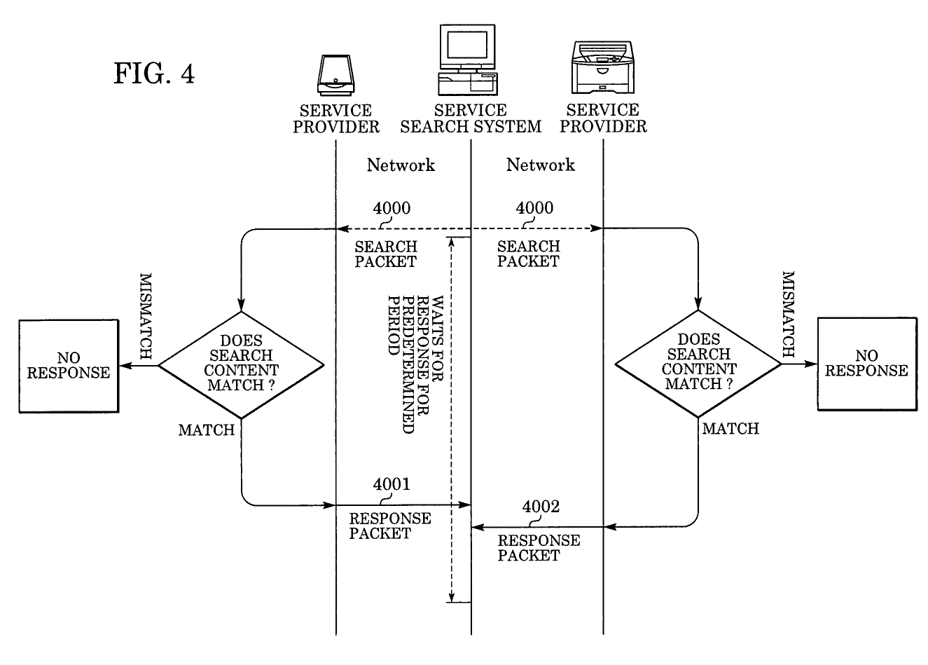

FIG. 4 shows an operation of searching for a service in a service discovery protocol using a general multicast technique. A service search packet 4000 is transmitted from service search software to a network by multicast. Service providers which have received the service search packet 4000 transmit their service content as response packets 4001 and 4002, respectively, if the service provided by the provider matches a search condition described in the service search packet. If the condition described in the received service search packet does not match the service content provided by the provider, the provider does not respond to the search packet and ignores it. After a service searcher has transmitted the service search packet 4000 to the network by multicast, the searcher waits for a response from the network for a predetermined period. If the searcher receives a response within the predetermined period, a service has been found. If the searcher does not receive a response within the predetermined period, a service to be searched for does not exist within the range of reach of the multicast packet.

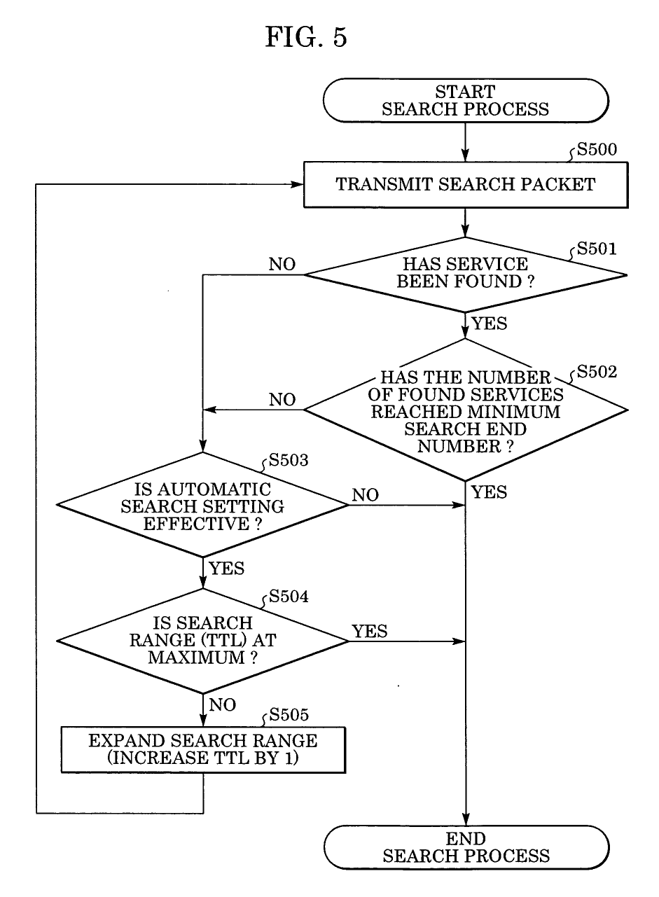

FIG. 5 is a flowchart showing an operation of the service search software performing search for one or more services.

First, in step S500, a service search packet is transmitted to a network by using a multicast packet. Network devices receive this service search packet and transmit a response to the service search software if the searched service matches the service provided by their own devices. In step S501, a response to the search packet transmitted in step S500 is waited for a predetermined period. If a response is received within the predetermined period, the searched service has been found, and the process proceeds to step S502. If a response is not received within the predetermined period, the process proceeds to step S503. In step S502, it is determined whether the number of services found in step S501 has reached a minimum search end number set in the search software. If the number has reached the minimum search end number, the search process is completed. If the number has not reached the minimum search end number, the process proceeds to step S503. In step S503, an automatic search setting set in the search software is referred to, and if the automatic search setting is effective, the process proceed to step S504. If the automatic search setting is ineffective, the search process is completed. In step S504, it is determined whether a search effective range (TTL) is set at a maximum value. If the search effective range is set at the maximum value, the search process is completed. If the search effective range has not reached the maximum value, the process proceeds to step S505. In step S505, the search range is expanded (if the search range is TTL, set at TTL+1). Then, the process returns to step S500, where the search process is performed again.

With this process, if no service can be found in the search range set in advance by using TTL, or if the number of found services does not reach a predetermined number, the TTL value can be increased so as to perform search again. By expanding the search range, a desired service can be found.

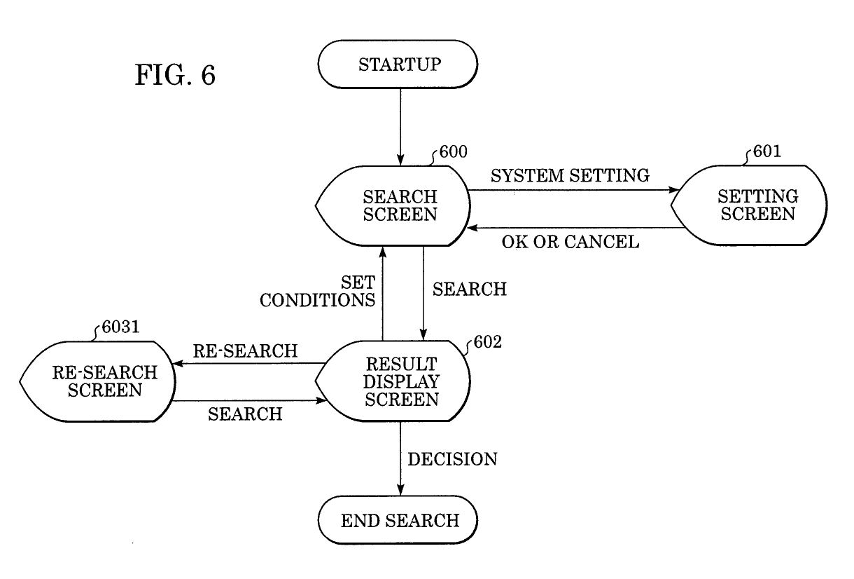

FIG. 6 illustrates transition of screens in the host computer (service search apparatus) in which the service search software is executed during the service search process of the present invention. After the service search software is started, a search screen 600 is started. In the search starting screen 600, setting in the service search system can be performed. By selecting search system setting, the screen changes to a search system setting screen 601.

Also, by setting search conditions in the search screen 600 and selecting search, the service search software searches for a service which satisfies the search conditions, and the screen changes to a result display screen 602.

The screen 601 is a setting screen for the service search system. Information including an effective range of search can be set on the screen 601. When “OK” or “cancel” is selected on the screen 601, the screen changes to the screen 600.

The screen 602 is a screen for displaying a result of service search. In the screen 602, when re-search is to be executed by changing the search range but without changing the search conditions according to a search result, re-search is selected so that the screen changes to a screen 603. If the searcher wants to change the search conditions, the searcher selects re-setting of conditions, so that the screen changes to the screen 600. If the search result includes a desired service, the searcher selects the service from the list, so that the search process is completed.

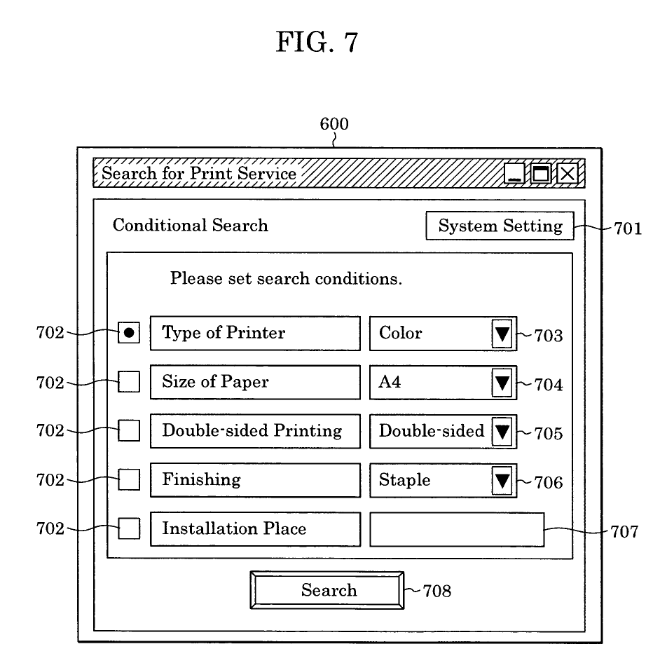

FIG. 7 is an example of the screen 600 shown in FIG. 6. In this case, a print service is searched for. However, the type of service to be searched for is not limited to a print service, but a scan service, a storage service, and so on, can be searched for by displaying a screen to which conditions corresponding to the respective services can be input.

A system settings button 701 is used for setting the search system. By pushing the system settings button 701, the screen changes to the screen 601. Check boxes 702 are used for validating search conditions which have been set. A searcher checks one or more of the check boxes 702 corresponding to one or more search conditions to be set. A plurality of search conditions may be selected, and in that case, a device which satisfies all of the search conditions is obtained as a search result. On the other hand, the searcher may not select any search condition. In that case, all devices providing a print service are obtained as a search result. The screen 600 includes sections for setting search conditions, for example section 703 is used for selecting color-print-compatible or monochrome-print-compatible in a print service, section 704 is used for selecting the size of paper used in the print service, section 705 is used for selecting double-sided printing, section 706 is used for selecting staple operation, and section 707 is used for selecting an installation place, all of them being specified as search conditions. Search for a print service is actually executed by pushing a search execution button 708. If search is executed under a state shown in FIG. 7, where “color” is selected as a type of printer, a search is executed for a printer compatible with color printing.

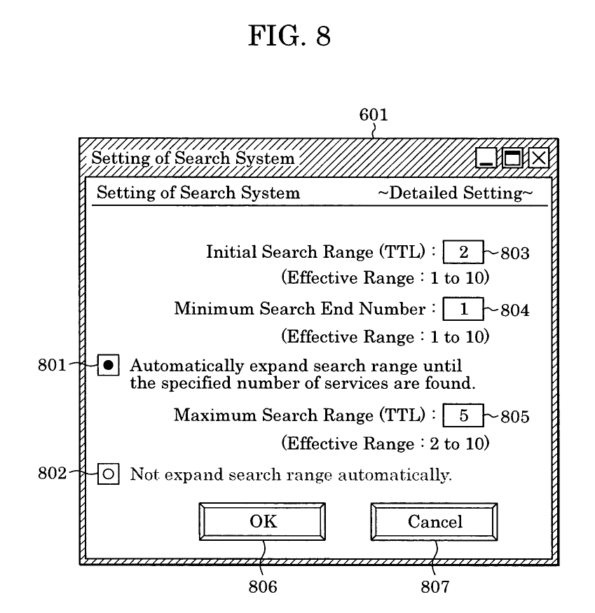

FIG. 8 is an example of the screen 601 shown in FIG. 6, used as a screen for setting the print service search system. Check boxes 801 and 802 are used for an automatic search function of the search software. These check boxes 801 and 802 are exclusively selected, so that only one of them can be selected. A first search process can be set using a box 803 in which the search range is set. In the embodiment, a value of the search range can be selected from among 1 to 10. A value “2” is set in FIG. 8. A minimum search end number can be set in a box 804. The number set here is used in step S502 in the flowchart shown in FIG. 5. After search for a print service has been done, a process performed thereafter changes depending on whether or not the number of print services found in the search is equal to or larger than the minimum search end number set in the box 804. A maximum search range can be set in a box 805. When the number of services found in the search is smaller than the number set in the box 804, the maximum search range is set again before performing re-search. In the embodiment, the search range is set by using a TTL value. In the example shown in FIG. 8, if one (the value in the box 804: the minimum search end number) service cannot be found as a result of search performed by setting the values in the boxes 803 and 804, the search range can be expanded up to 5 in the TTL value. An OK button 806 is used for confirming the setting of the search system. A cancel button 807 is used for canceling the setting. By selecting the OK button 806 or the cancel button 807, the screen changes to the screen 600 shown in FIG. 7 and described above.

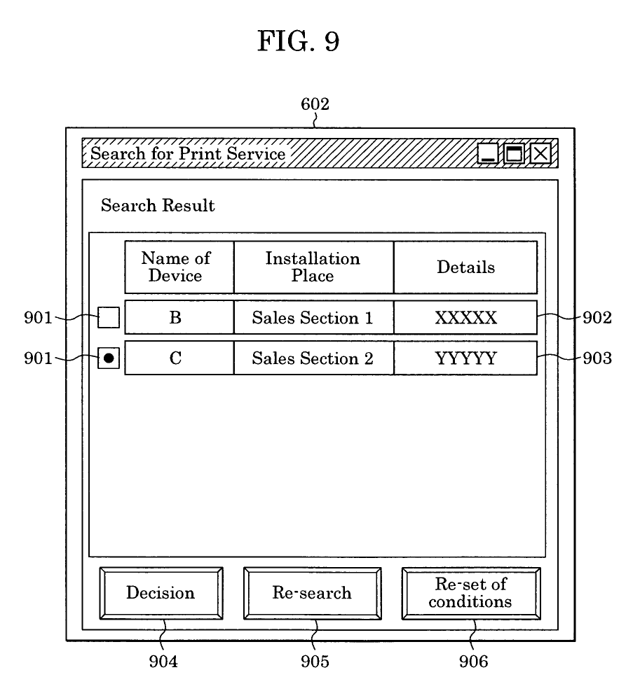

FIG. 9 shows an example of the screen 602 shown in FIG. 6, which is the search result display screen. Check boxes 901 are used for selecting a service which has been found in the search process. A plurality of services can be selected. Service boxes 902, 903 display information about found services. As the information about the found services, the name of device, installation place, and details thereof are displayed in FIG. 9, but the displayed information is not limited to these items. The screen shown in FIG. 9 indicates that two services 902 and 903 have been found. If no service has been found, the result is displayed so as to urge the user to perform re-search. A button 904 is used for deciding the service(s) selected by using the check box(s) 901. By pushing button 904, the search process is completed. A button 905 is used for performing re-search without changing the search conditions. By pushing the button 905, the screen changes to the screen 603. A button 906 is selected for setting the search conditions again before re-search. By pushing button 906, the screen changes to the screen 600 shown in FIG. 7 and described above.

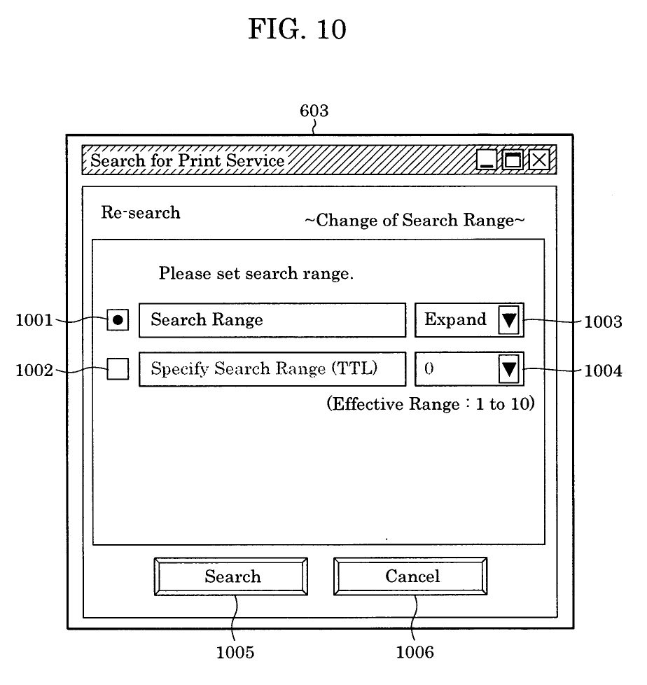

FIG. 10 shows an example of the screen 603 shown in FIG. 6, which is the re-search screen of the service search software. Check boxes 1001 and 1002 are used for specifying a search range, only one of which being selected. By checking the check box 1001, the search range can be expanded or narrowed compared to that in the previous search. By checking the check box 1002, a search method can be set by specifying the search range. In FIG. 10, selection is made to perform search by expanding the search range compared to the previous search. A section 1003 is provided for selecting to expand or narrow the search range compared to the previous search. A section 1004 in which the search range is selected from among 1 to 10 regardless of the previous search is also provided. A button 1005 is used for executing re-search under the condition set in the check box 1001 or 1002. When this button 1005 is pushed, re-search is executed and the result thereof is displayed in the search-result display screen 602 shown in FIG. 9 and described above. A button 1006 is used for canceling re-search. By pushing this button 1006, the screen changed to the previous screen 602 shown in FIG. 9.

Next, in the embodiment where a TTL value is used as a service search range, a case where setting has been done in the search system in the manner shown in FIG. 8 will be described.

First, a case where search for a print service is performed by the PC 130 shown in FIG. 1 will be described.

When the PC 130 searches for a print service, the initial search range TTL is set to 2 in the service search system. Thus, the PC 130 can search for a service beyond the router 230, so that the PC 130 can search for a print service existing on the networks 440 and 420. However, no print service exists on the networks 440 and 420, and thus the PC 130 cannot find a print service. However, on the setting screen for setting the search system (FIG. 8), setting has been done so that search is continued until the number of found services reaches 1 and that search is finished when the search range (TTL) becomes 5. Therefore, the value of TTL is increased by 1 and search is performed again under TTL=3. Under this state, the search packet can go over two routers, so that the PC 130 can search for a print service over the network 410 in addition to the networks 440 and 420. In the network 410, there exist devices 310 and 320 capable of providing a print service, so that the service search system can find the print services 310 and 320.

Next, a case where a print service is searched for from the PC 110 shown in FIG. 1 is described.

When the PC 110 searches for a print service, since the initial search range set in the service search system is TTL=2, the PC 110 can search for a service by going over each of the routers 200, 210, and 220. Therefore, print services existing on the networks 400, 410, 420, and 430 can be searched for. Eight print services exist on these networks, and thus the eight services are detected by service search. Here, the re-search button 905 is selected on the search result display screen (FIG. 9) in order to move to the print service re-search screen. By setting the item in the section 1003 in FIG. 10 to “narrow”, checking the check box 1001, and pushing the search button 1005, a search packet for a print service in which TTL=1 is transmitted. Since the search packet of TTL=1 cannot go over a router, print services on only the network 410 are searched for. On the network 410, there are two devices 310 and 320 for providing a print service, so that these print-service providing devices 310 and 320 are found. In this way, the obtained search result can be narrowed without changing search conditions.

The present invention is also achieved when a computer (or CPU or MPU (micro-processing unit)) of a system or an apparatus reads program code of software which realizes the function of the above-described embodiment from a storage medium and executes the program code.

In that case, the program code read from the storage medium realizes the function of the above-described embodiment.

Examples of the storage medium for supplying the program code include a floppy disk, a hard disk, an optical disk, a magneto-optical disk, a CD-ROM (compact disk-ROM), a CD-R (CD-recordable), a DVD (digital versatile disk) ROM, a DVD-R, a magnetic tape, a nonvolatile memory card, a ROM, a storage device of a file server on a network, and a storage device of an FTP (file transfer protocol) server on the Internet.

The function of the above-described embodiment may be realized when the computer reads and executes the program code. Alternatively, an operating system (OS) operated in the computer may execute part or all of actual processing based on the instructions of the program code, and the processing may allow the function of the above-described embodiment to be realized.

While the present invention has been described with reference to an exemplary embodiment, it is to be understood that the invention is not limited to the disclosed embodiment. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-116801 filed Apr. 12, 2004, which is hereby incorporated by reference herein.

1. An information processing apparatus connected to a plurality of devices through a communication medium, the apparatus comprising:
a transmitting unit adapted to transmit a search request to one or more devices existing in a first area;
a receiving unit adapted to receive a response to the search request from one or more devices; and
a control unit adapted to control the transmitting unit to transmit the search request to one or more devices existing in a second area when the number of devices that have responded to the search request transmitted by the transmitting unit is less than a predetermined number.

2. The information processing apparatus according to claim 1, wherein the second area includes the first area and is wider than the first area.

3. The information processing apparatus according to claim 1, wherein the control unit allows the transmitting unit to transmit the search request to the one or more devices existing in the second area when no device responds to the search request transmitted by the transmitting unit.

4. The information processing apparatus according to claim 1, further comprising an input unit adapted to allow a user to input the predetermined number.

5. The information processing apparatus according to claim 1, wherein the first area is a sub-network to which the information processing apparatus belongs and the second area is any sub-network to which the information processing apparatus does not belong.

6. An information processing apparatus connected to a plurality of devices through a network, the apparatus comprising:
a transmitting unit adapted to transmit a search request for searching for one or more devices to the network;
a receiving unit adapted to receive a response to the search request;
a determining unit adapted to determine whether the number of devices satisfying the search request is less than a predetermined number; and
a control unit adapted to control the transmitting unit to retransmit the search request by widening a range within which the search request is transmitted if it has been determined that the number of devices satisfying the search request is less than the predetermined number.

7. The information processing apparatus according to claim 6, further comprising an input unit adapted to allow a user to input the range within which the search request is retransmitted.

8. The information processing apparatus according to claim 6, wherein the search request transmitted by the transmitting unit is transmitted by multicast and the range within which the search request is transmitted is controlled by time to live.

9. The information processing apparatus according to claim 6, further comprising an input unit adapted to allow a user to input an upper limit of the range that is widened before retransmitting the search request.

10. An information processing apparatus connected to a plurality of devices through a network, the apparatus comprising:
a transmitting unit adapted to transmit a search request for searching for one or more devices to the network;
a receiving unit adapted to receive a response to the search request;
a determining unit adapted to determine whether the number of devices satisfying the search request is greater than a predetermined number; and
a control unit adapted to control the transmitting unit to retransmit the search request by narrowing a range within which the search request is transmitted if it has been determined that the number of devices satisfying the search request is greater than the predetermined number.

11. The information processing apparatus according to claim 10, further comprising an input unit adapted to allow a user to input the range within which the search request is retransmitted.

12. The information processing apparatus according to claim 10, wherein the search request transmitted by the transmitting unit is transmitted by multicast and the range within which the search request is transmitted is controlled by time to live.

13. The information processing apparatus according to claim 10, further comprising an input unit adapted to allow a user to input a lower limit of the range that is narrowed before retransmitting the search request.

14. An information processing method in an information processing apparatus connected to a plurality of devices through a communication medium, the method comprising:
a transmitting step of transmitting a search request to one or more devices existing in a first area;
a receiving step of receiving a response to the search request from one or more devices; and
a control step of controlling a transmitting unit to transmit the search request to one or more devices existing in a second area when the number of devices that have responded to the search request transmitted in the transmitting step is less than a predetermined number.

15. A computer-readable storage medium for allowing an information processing apparatus connected to a plurality of devices through a network to execute steps according to claim 14.

16. An information processing method in an information processing apparatus connected to a plurality of devices through a network, the method comprising:
a transmitting step of transmitting a search request for searching for one or more devices to the network;
a receiving step of receiving a response to the search request;
a determining step of determining whether the number of devices satisfying the search request is less than a predetermined number; and
a control step of controlling a transmitting unit to retransmit the search request by widening a range within which the search request is transmitted if it has been determined that the number of devices satisfying the search request is less than the predetermined number.

17. A computer-readable storage medium for allowing an information processing apparatus connected to a plurality of devices through a network to execute steps according to claim 16.

18. An information processing method in an information processing apparatus connected to a plurality of devices through a network, the method comprising:
a transmitting step of transmitting a search request for searching for one or more devices to the network;
a receiving step of receiving a response to the search request;
a determining step of determining whether the number of devices satisfying the search request is greater than a predetermined number; and
a control step of controlling a transmitting unit to retransmit the search request by narrowing a range within which the search request is transmitted if it has been determined that the number of devices satisfying the search request is greater than the predetermined number.

19. A computer-readable storage medium for allowing an information processing apparatus connected to a plurality of devices through a network to execute steps according to claim 18.
